(19) United States
(12) Patent Application Publication
(10) Pub. No.: US 2005/0053026 A1
(43) Pub. Date: Mar. 10, 2005

(54) Mobile airborne high-speed broadband communications systems and methods

(75) Inventors: Thomas E. Mullan, Arnold, MD (US); William H. Mosberg III, Arnold, MD (US); Bruce F. Miller, Annapolis, MD (US); Steven L. Horr, Millersville, MD (US)

Correspondence Address: OLIFF & BERRIDGE, PLC, P.O. BOX 19928, ALEXANDRIA, VA, 22320, US

(73) Assignee: ARINC, INCORPORATED, Annapolis, MD (US)

(21) Appl. No.: 10/658,776

(22) Filed: Sep. 10, 2003

(51) Int. Cl. H04B 7/185

(52) U.S. Cl. 370/316

(57) ABSTRACT

Improved high-speed, broadband data communication between a mobile terminal, including aircraft in flight, and secure, private remote networks, can be implemented by using the bandwidth of a single transponder on a satellite. The improved high-speed data communications system uses a single frequency to transmit the broadband data from the mobile terminal to the satellite and the same frequency to transmit the broadband data from the remote network to the satellite. Likewise, the improved high-speed data communications system uses a corresponding frequency on the same satellite transponder to transmit the high-speed, broadband data from the satellite to the mobile terminal and to transmit the high-speed, broadband data from the satellite to the remote network.

### BACKGROUND OF THE INVENTION

1. Field of Invention

This invention relates to systems and methods for communicating from a mobile airborne user to and from a remote network via high-speed broadband communications signals.

2. Description of Related Art

Methods and systems for communicating from a mobile airborne user to a remote network are known. For example, U.S. Pat. No. 6,201,797 to Leuca et al. (“Leuca”) discloses a system that uses a low-bandwidth air-to-ground communication system uplink (return link) to request data, where the requested data is subsequently transmitted over a separate, high-bandwidth communication system downlink (forward link). In Leuca's system, one antenna transmits the low-bandwidth air-to-ground request for data from the mobile airborne user. A second antenna on the airborne aircraft later receives the requested data transmitted over the high-bandwidth communication system downlink. The low-bandwidth air-to-ground request for data is transmitted directly from the airborne aircraft to a ground-based gateway of a remote network. The high-bandwidth transmission of the requested data from the ground is relayed to the airborne aircraft through a satellite system.

The Boeing Connexion system is an aeronautical mobile satellite system that uses a large antenna array for communications with a mobile aircraft. The Connexion system uses two satellite transponders, one for forward communications and one for return communications.

The Inmarsat Swift 64 system is another system for communicating between an airborne aircraft and a remote network. The Inmarsat Swift 64 transmits communication signals exclusively on dedicated, 64 kbps bandwidth channels.

### SUMMARY OF THE INVENTION

A large proportion of business travelers carry laptop computers and other data processing devices equipped to receive and transmit information and data, including email and Internet access. Often, such business travelers have a desire to connect with existing data services while in transit. Likewise, these business travelers also often have a desire to transmit and receive large files as quickly as possible. Achieving these goals requires a high bandwidth communications medium, such as a broadband satellite.

Modern communication satellites subdivide the communications space, i.e., the communications bandwidth, available on such communication satellites into various sets of frequency ranges. Each frequency range corresponds to a transponder on the satellite. Currently, the cost of leasing a single transponder on a single satellite, corresponding to a single frequency range, is on the order of two million dollars per year. Thus, it is desirable, for reasons of cost effectiveness, to minimize the number of satellite transponders necessary to operate a mobile airborne communications system.

The above-described mobile airborne communications systems and methods have several disadvantages. The Boeing Connexion system requires two large antenna arrays that are not practical on smaller aircraft, such as regional commuter aircraft, business jets and other small commercial or private aircraft. The large antenna arrays required by the Boeing Connexion system also require substantial space and substantial power to operate, which is not available on the smaller aircraft. The Boeing Connexion system requires two transponders on a satellite to operate, one for transmitting to the aircraft and one for receiving from the aircraft. The Boeing Connexion system supports a dedicated service, with the access control server located on the aircraft.

The Inmarsat Swift 64 system uses a single small, fixed antenna, operating at a data rate of 64 kbps. Two Swift 64 systems, including a second aircraft antenna, may be operated in parallel to achieve a moderate data rate of 128 kbps. As with the Boeing Connexion and Inmarsat Swift 64 systems, Leuca's system uses multiple antennas and multiple ground receiver stations in an airborne mobile communications system.

Though satellite communications systems are now available to commercial airline travelers on large aircraft, size and power limitations make this technology harder to use on small aircraft, such as small business jets used by the business community. Nevertheless, business executives and other members of the business jet community who travel for business purposes on small aircraft often have a greater desire or a greater need for a high-speed broadband satellite communications system and method while in transit. Thus, though satellite communication systems now exist for commercial airline travelers on large commercial aircraft, such systems are unavailable where the demand is the greatest. Businesses and corporations have purchased thousands of small corporate aircraft and business jets to improve efficiency and productivity during business travel. The inventors have determined that the ability to implement mobile airborne high-speed broadband communications in a small business jet or similar mobile environment is desirable.

This invention provides systems and methods for communicating with a mobile platform using satellite-based high-speed broadband channels.

This invention further provides systems and methods for communication with a highly-maneuverable mobile platform using satellite-based high-speed broadband channels.

This invention separably provides systems and methods for communicating with a mobile platform using a single satellite transponder for communication both to and from the mobile platform.

This invention separably provides systems and methods for communicating with a mobile platform using a small antenna suitable for use on a small mobile platform.

This invention separably provides systems and methods for communicating with a mobile platform using an antenna that has reduced power and space requirements.

This invention separably provides systems and methods for communicating with a mobile platform using a single mobile satellite antenna.

This invention separably provides systems and methods for communicating with a mobile platform using a remote base station.

This invention separably provides systems and methods for communicating with a mobile platform by recovering a lower-power signal transmitted at a given frequency from a different higher-power signal transmitted at the same given frequency.

Various exemplary embodiments of the systems and methods according to this invention use a single uplink frequency for transmissions to the satellite, including both communications from a base station, such as a ground earth station (GES), to the satellite and communications from a mobile platform, such as an airborne aircraft, to the satellite. Likewise, downlink transmissions, that is, transmissions both from the satellite to the base station and from the satellite to the mobile platform, such as the aircraft, are on the same downlink frequency.

One difficulty associated with operating a bi-directional communication system over a single satellite using a single frequency set on a single transponder is that it is difficult to recover data at a low-power buried underneath other data at a higher power on that same frequency. In various exemplary embodiments of the systems and methods according to this invention, a low-power signal can be recovered from under a high-power signal on the same frequency.

Various exemplary embodiments of the systems and methods according to this invention use a single satellite transponder for communications from the satellite to the mobile platform, such as the airborne aircraft, and from the satellite to the base station, such as the ground earth station. Likewise, the same single satellite transponder is used for communications from the mobile platform, such as the airborne aircraft, to the satellite, and from the base station, such as the ground earth station, to the satellite.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of the systems and methods of this invention will be described in detail, with reference to the following figures, wherein:

FIG. 1 is a schematic diagram of one exemplary embodiment of a mobile platform high-speed broadband communications system according to this invention;

FIG. 2 is a schematic diagram of a second exemplary embodiment of the mobile platform high-speed broadband communications system according to this invention, showing greater detail of the airborne aircraft and greater detail at a location remote from the airborne aircraft;

FIG. 3 is a schematic diagram of a third exemplary embodiment of the mobile platform high-speed broadband communications system according to this invention, illustrating an application with various communications systems; and

FIGS. 4 and 5 are flowcharts outlining one exemplary embodiment of a method for mobile platform high-speed broadband communications according to this invention.

### DETAILED DESCRIPTION OF EXEMPLARY EMBODIMENTS

The following detailed description of various exemplary embodiments of the mobile high-speed broadband satellite communication systems according to this invention may refer to one specific type of mobile high-speed broadband satellite communication system, an airborne mobile high-speed broadband satellite communication system, for sake of clarity. However, it should be appreciated that the principles of this invention, as outlined and/or discussed below, can be equally applied to any known or later-developed mobile high-speed broadband satellite communication systems, and mobile devices, such as, for example, marine and terrestrial mobile devices, such as buses, trains, trucks, HUM-VEEs, and the like, beyond the airborne mobile high-speed broadband satellite communication systems and mobile airborne aircraft specifically discussed herein.

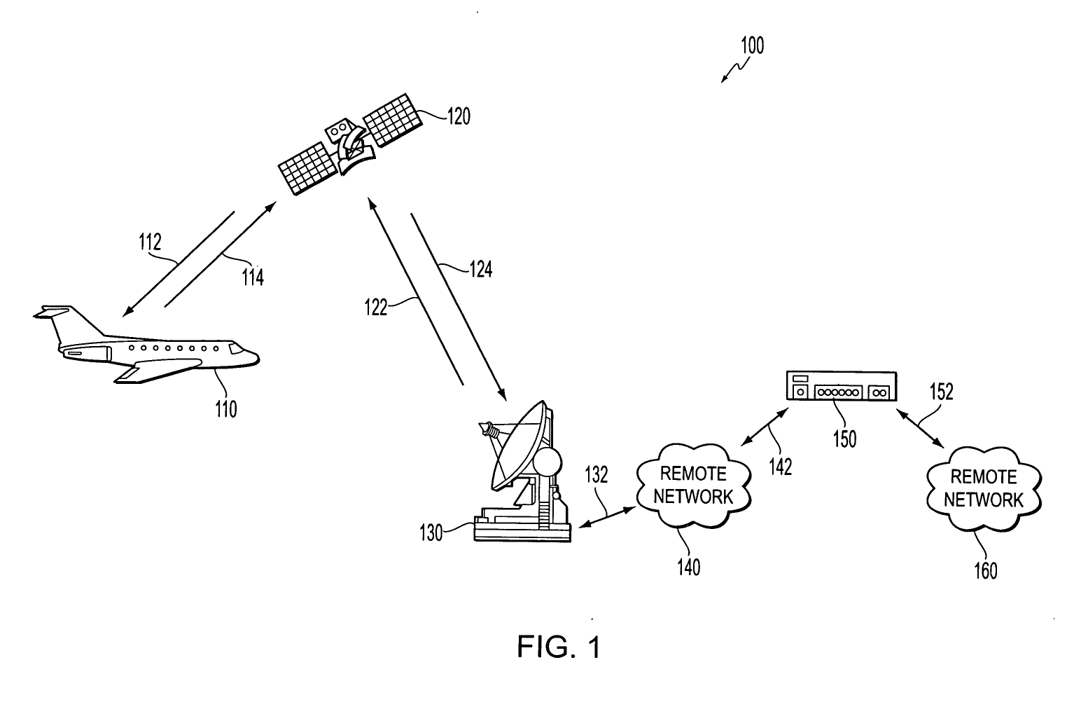

FIG. 1 is a schematic diagram of one exemplary embodiment of a mobile platform high-speed broadband communications system 100 according to this invention. As shown in FIG. 1, the mobile airborne high-speed broadband communications system 100 includes at least one aircraft 110, and may, in various exemplary embodiments, include multiple aircraft 110 that are, in various exemplary embodiments, separately addressed.

The mobile airborne high-speed broadband communications system 100 is designed primarily with air travel in mind. However, the mobile airborne high-speed broadband communications system 100 also operates when the aircraft 110 is in motion on the ground, such as when the aircraft 110 is taxiing on the runway before takeoff or after landing. In the same manner, the mobile airborne high-speed broadband communications system 100 can operate when the aircraft 110 is stationary on the ground, such as after boarding but prior to departure, and while awaiting authorization to take-off. Whether the aircraft 110 is in motion or stationary, or in the air or on the ground, the mobile airborne high-speed broadband communications system 100 operates in the same manner. Thus, the aircraft 110 may be a mobile aircraft, a stationary aircraft, an airborne aircraft, or a grounded aircraft. These descriptive terms may be used interchangeably throughout to refer to the aircraft 110.

The aircraft 110 is in communication with a satellite 120 via an uplink communications path 114 and a downlink communications path 112. The downlink communications path 112 carries a signal transmitted from the satellite 120 “down” to the aircraft 110. The uplink communications path 114 carries a signal transmitted from the aircraft 110 “up” to the satellite 120.

The satellite 120 is also in communications with a base station 130 via an uplink communications path 122 and a downlink communications path 124. As with communications between the satellite 120 and the aircraft 110, the uplink communications path 122 carries a signal transmitted from the base station 130 “up” to the satellite 120. Similarly, the downlink communications path 124 carries a signal transmitted from the satellite 120 “down” to the base station 130.

Although the satellite 120 is typically at a higher altitude than both the aircraft 110 and the base station 130, this is not necessarily the case. Thus, in various exemplary embodiments, the aircraft 110 may be at an altitude higher than the satellite 120. An example of an aircraft 110 in such an embodiment is a spacecraft. In other exemplary embodiments, the base station 130 is at a higher altitude than the satellite 120. An example of a base station 130 in such an embodiment is a space station. In other exemplary embodiments, both the aircraft 110 and the base station 130 are at an altitude higher than the satellite 120, such as where both the aircraft 110 and the base station 130 are in outer space. Thus, the “base station” as used throughout is not intended to be limited to an earth-based station.

With such exemplary embodiments in mind, it should be apparent that the uplink communications paths 114 and 122 and the downlink communications paths 112 and 124 are not intended to describe any necessary positional relationship, such as altitude, between physical objects, such as the aircraft 110, the satellite 120, and the base station 130. Rather, references to an “uplink” or a “downlink” are intended to be symbolic references.

The downlink communications paths 112 and 124 from the satellite 120 use the same frequency. It should be appreciated that the downlink transmissions from the satellite 120 are transmitted to the entire footprint of the communications range of the satellite 120. Thus, the information transmitted along the downlink communications path 112 is received at the base station 130 as well as at the aircraft 110. Likewise, information transmitted along the downlink communications path 124 is received at the aircraft 110 as well as at the base station 130. Similarly, all other physical points or locations capable of receiving a communications signal from the satellite 120, by virtue of their presence in the broadcast footprint of the satellite 120, will receive all downlink signals transmitted along the communication paths 112 and 124.

This is also true for the uplink communications paths 114 and 122. That is, the frequency on which the signals are transmitted from the aircraft 110 along the uplink communications path 114 is the same frequency on which signals are transmitted from the base station 130 along the uplink communications path 122. All communications from any point in the footprint of the satellite 120, including the aircraft 110 and the base station 130, intended to be received by the satellite 120, are transmitted on that same frequency.

A single transponder on the satellite 120 has a bandwidth that encompasses the specific uplink and downlink frequencies. Thus, a single transponder in the satellite 120 is used for communications along the communications paths 112, 114, 122 and 124. It is not necessary to use more than one transponder on the satellite 120 to achieve discrete communications signals for transmitting along the downlink communications path 112, the uplink communications path 114, the uplink communications path 122, and the downlink communications path 124. Likewise, in various exemplary embodiments, it is not necessary to employ more than one satellite 120 in the mobile airborne high-speed broadband communications system 100 in the exemplary embodiment depicted in FIG. 1. As a result, cost savings are achieved over mobile airborne communications systems that require more than one satellite and/or more than one satellite transponder to operate.

It should be noted that, in various other exemplary embodiments, the mobile airborne high-speed broadband communications system 100 includes more than one satellite 120, and, in various other exemplary embodiments, includes more than one satellite transponder. Such exemplary embodiments accommodate service expansion. In such exemplary embodiments, a given aircraft 110 communicates with only one satellite transponder until it moves beyond that satellite transponder's coverage area (footprint) to the footprint of another satellite.

An associated physical aspect of the mobile airborne high-speed broadband communications system 100 according to this invention, that uses a single satellite 120 and a single transponder on the satellite 120 for signals transmitted along the uplink communications paths 114 and 122, a single uplink communications frequency, a single downlink communications frequency for signals transmitted along the downlink communications paths 112 and 124, and thus a single frequency range of communications to and from the satellite 120, is that communications between the aircraft 110, the satellite 120 and the base station 130 can be implemented on a single circuit or transponder within the satellite 120. Thus, the signals contained in the downlink communications path 112, the uplink communications path 114, the uplink communications path 122, and the downlink communications path 124 are processed at the satellite 120 by a single circuit or transponder. It should be apparent that this represents a cost savings and an improved efficiency over mobile airborne communications systems that employ or require more than one circuit or transponder for processing communications between an aircraft and a base station via a satellite or satellites in the system.

Although the signal transmitted along the downlink communications path 112 and the signal transmitted along the downlink communications path 124 from the satellite 120 are transmitted on the same frequency, the aircraft 110 distinguishes signals intended for the aircraft 110 from signals intended for the base station 130. Likewise, the base station 130 distinguishes signals intended for the base station 130 from signals intended for the aircraft 110.

A signal intended to be received by the aircraft 110 is transmitted from the base station 130 along the uplink communications path 122 to the satellite 120. This signal is then relayed or retransmitted from the satellite 120 along the downlink communications path 112 to the aircraft 110 as intended, but also along the downlink communications path 124 back to the base station 130. Thus, a signal transmitted from the base station 130 to the satellite 120 along the uplink communications path 122 is returned to the base station 130 from the satellite 120 along the downlink communications path 124. At the same time, a signal originating at the aircraft 110, intended for the base station 130, is transmitted to the satellite 120 along the uplink communications path 114 and then relayed or retransmitted from the satellite 120 along the downlink communications path 112 back to the aircraft 110 as well as along the downlink communications path 124 to the base station 130 as intended.

In this manner, the base station 130 often receives at least two discrete signals from the satellite 120 along the downlink communications path 124: signals originally transmitted from the base station 130 intended for the aircraft 110 and signals originated at the aircraft 110 intended for the base station 130. In the same manner, the aircraft 110 often receives at least two discrete signals along the downlink communications path 112 from the satellite 120: signals that originated at the aircraft 110 intended for the base station 130 and signals that originated at the base station 130 intended for the aircraft 110.

These dual signals transmitted by the satellite 120 to its entire footprint, including along the downlink communications path 112 and the downlink communications path 124, typically vary in intensity. Typically, a signal that originated at the aircraft 110 that is intended for the base station 130 is at a lower power level than a signal that originated at the base station 130 that is intended for the aircraft 110. Thus, it is relatively easy to distinguish a signal that originated at the base station 130 that is intended for the aircraft 110, when received from the satellite 120 by the aircraft 110 along the downlink communications path 112 from the satellite 120, from a lower power signal that originated at the aircraft 110 that is intended for the base station 130 that is returned to the aircraft 110 by the satellite 120. For example well-known techniques can be employed to extract a signal from the base station 130 that is intended for the aircraft 110 that is transmitted along the downlink communications path 112 from the satellite 120 at a higher power than a signal that originated at the aircraft 110 that is intended for base station 130 that is concurrently transmitted back to the aircraft 110 from the satellite 120 along the downlink communications path 112 at a lower power.

Techniques to distinguish and extract a lower-power signal that originated at the aircraft 110 that is intended for the base station 130, received at the base station 130 from the satellite 120 along the downlink communications path 124, from a concurrently-received signal that originated at the base station 130 that is intended for aircraft 110 that has been rebroadcast back to the base station 130 from the satellite 120 along the downlink communications path 124 are also known. Such techniques may be referred to as hub canceller technology. Thus, an apparatus that employs this technology, such as a ground receiver station or the base station 130, may be referred to alternatively as a hub canceller, or as including a hub canceller.

The signal transmitted from the base station 130 that is intended for the aircraft 110 is also referred to as the forward link component of the signal transmitted from the satellite 120 to its footprint, including the downlink communications path 112 and the downlink communications path 124. The signal transmitted from the aircraft 110 that is intended for the base station 130 is referred to as the return link component of the signal transmitted from the satellite 120 to its footprint, including the downlink communications path 112 and the downlink communications path 124. In various exemplary embodiments, the amplitude of the forward link component of the downlink signal from the satellite 120 received by the base station 130 is 10-20 db higher than the amplitude of the return link component of that downlink signal received by the base station 130. Hub cancellers employ systems and methods for extracting the lower-power return link component of that signal.

In one exemplary embodiment of the mobile airborne high-speed broadband communications system 100 according to the current invention, the satellite 120 operates in the Ku-band. Thus, in various exemplary embodiments of the systems and methods according to this invention, on a single transponder, the forward link signal component uplinked to the satellite 120 via the uplink communications path 122 and the return link signal component uplinked to the satellite 120 via the uplink communications path 114 share the same satellite uplink frequency range of 14.0-14.5 GHz. Similarly, in these exemplary embodiments, on a single transponder, the forward link signal component downlinked from the satellite 120 to the aircraft 110 via the downlink communications path 112 and the return link signal component downlinked from the satellite 120 to the base station 130 via the downlink communications path 124 share the same satellite downlink frequency range of 11.7-12.2 GHz. It should be apparent that a variety of frequency ranges not limited to the Ku-band, but inclusive of L-band, S-band and Ka-bands and higher, as they become commercially available, can be used in different exemplary embodiments of the systems and methods according to the invention.

In various exemplary embodiments, the return link signal component is a relatively small data request. Thus, in these exemplary embodiments, the bandwidth requirement to transmit the return link signal component is minimal. Conversely, in these exemplary embodiments, the forward link signal component contains information requested by the return link signal component. The data provided in response to a data request in these exemplary embodiments is much larger than the size of the data comprising the data request itself. Therefore, in these exemplary embodiments, the forward link signal component requires, and is allocated, much more bandwidth than in required by the return link signal component.

It should be noted that, in other exemplary embodiments, it may be desirable to send a large amount of data via the return link signal component. For example, in some exemplary embodiments a person on the aircraft 110 desires to share a file with a person that is not on the aircraft 110. In such exemplary embodiments, it may take longer to transfer the file than it does to request data. In these exemplary embodiments, the parameters of the mobile airborne high-speed broadband communications system 100 do not change but simply adjust to the demand.

The base station 130 is in communication with a remote network 140 through a communications path 132. A node of the remote network 140 serves as a communications portal through which communications signals pass to and from an access management server 150, through a communications path 142. The forward link communications signals pass from the access management server 150 through the communications path 142, and through the remote network 140 to the base station 130 via the communications path 132. In the same manner, the return link communications signals pass from the base station 130 through the remote network 140 via the communications path 132 and through the communications path 142 to the access management server 150. In some exemplary embodiments, the communications paths 132 and 142 may be terrestrial links or other satellite links.

In the exemplary embodiment shown in FIG. 1, the return link signal component received at the access management server 150 from the remote network 140 via the communications path 142. The access management server 150 controls access to a remote network 160. In this exemplary embodiment, the access management server 150 authenticates the return link signal component transmitted from the remote network 140 via the communications path 142. Upon authenticating the return link signal component, the access management server 150 permits the return link signal component to access the remote network 160 via the communications path 152. In this exemplary embodiment, upon completion of the authentication process, the access management server 150 transmits a service initiation acknowledgement message via the forward link communications signal. Thus, in this exemplary embodiment, the access management server 150 performs the functions of operation, administration, maintenance and provisioning (OAM&P). In such exemplary embodiments, users on the aircraft 110 become a part of a secure private network that is managed by the access management server 150.

It should be appreciated that, although FIG. 1 depicts only one base station 130, in various other exemplary embodiments, more than one base station 130 is included in the mobile airborne high-speed broadband communications system 100. Thus, in various exemplary embodiments, certain base stations 130 are assigned to cover communications with certain portions of the airspace. Similarly, in various exemplary embodiments, certain base stations 130 are assigned to cover communications with certain aircraft 110.

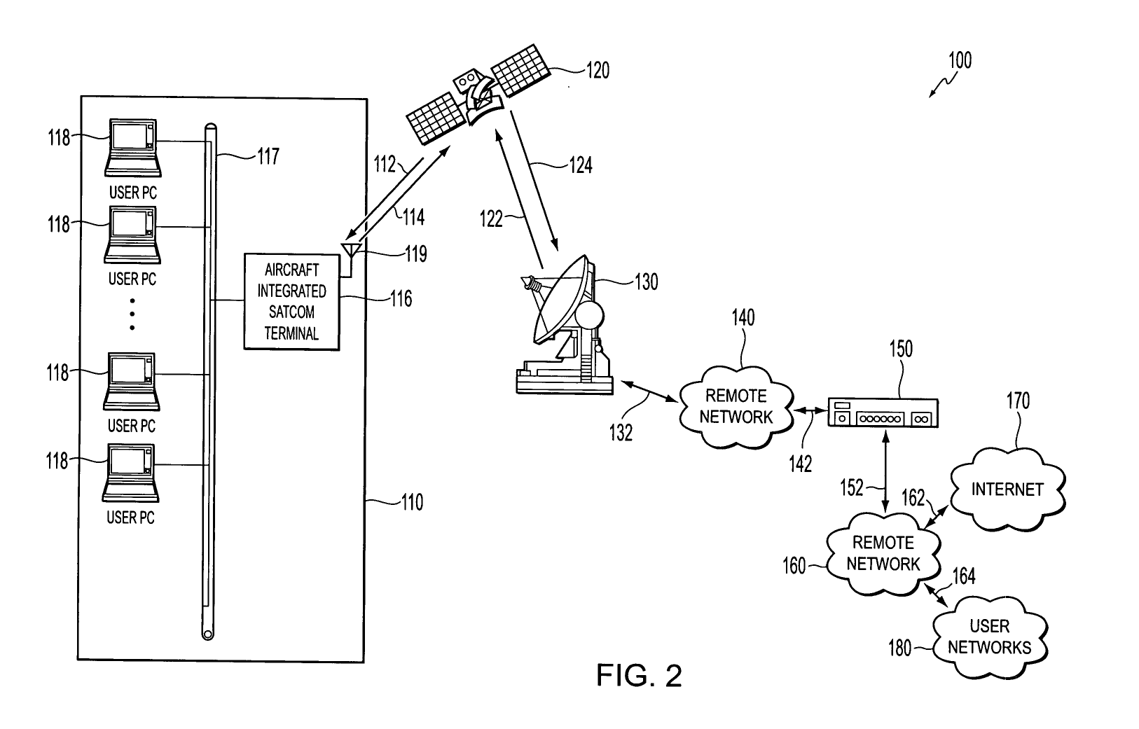

FIG. 2 shows a schematic diagram of a second exemplary embodiment of the mobile airborne high-speed broadband communications system 100 according to the invention, showing greater detail of the airborne aircraft 110 and depicting exemplary services that may be accessed via the mobile airborne high-speed broadband communications system 100. Several of the elements of the embodiment of the mobile airborne high-speed broadband communications system 100 shown in FIG. 1 are also shown in FIG. 2. To the extent that these elements are duplicated in FIG. 2, a detailed description of those elements is the same as the detailed description previously provided in connection with FIG. 1, and will not be repeated in connection with FIG. 2.

As shown in FIG. 2, the aircraft 110 includes a number of user PCs 118, an aircraft data pipe 117, and an aircraft integrated satellite communications SATCOM terminal (AIST) 116. For example, in various exemplary embodiments, the user PCs 118 include one or more portable laptop computers carried on to the aircraft 110 for use during flight by one or more air travelers. It should be appreciated that the user PCs 118 are, in various embodiments, any form of a user workstation, display and/or a data entry mechanism, or a personal electronic device (PED). Thus, in various embodiments, the user PCs 118 need not be portable laptop computers.

In various exemplary embodiments, the user PCs 118 are laptop computers, displays or personal electronic devices carried on board by members of the flight crew, or maintenance personnel. In still other exemplary embodiments, the user PCs 118 are workstations, displays, and/or a data entry devices provided within the aircraft 110 in a dedicated manner for the repeated use by subsequent passengers or crew of the aircraft 110 while on board. In still other exemplary embodiments, the user PCs 118 are any combination of the user PCs 118 previously described.

The user PCs 118 are connected to the aircraft data pipe 117 in a well-known manner. The aircraft data pipe 117 transmits data within the aircraft 110 in a well-known manner. Thus, the aircraft data pipe 117 is, in various embodiments, a cabin distribution system (CDS), an integrated services digital network (ISDN), a local area network (LAN), an Ethernet, a fiber-distributed data interface network (FDDI), and/or an asynchronous transmission mode network (ATM).

The aircraft data pipe 117 is connected to the aircraft integrated SATCOM terminal (AIST) 116. Thus, the users operating the user PCs 118 are connected to the aircraft integrated SATCOM terminal 116 through the aircraft data pipe 117. The aircraft integrated SATCOM terminal 116 performs a flow-control function between the user PCs 118 and the satellite 120 via an antenna 119. Thus, the aircraft integrated SATCOM terminal 116 functions as a gateway performing data control functions between the aircraft data pipe 117 and the satellite 120.

In various exemplary embodiments, the aircraft integrated SATCOM terminal 116 includes network interface functionality. In such exemplary embodiments, the network interface functionality enables the aircraft integrated SATCOM terminal (AIST) 116 to connect with the aircraft data pipe 117 according to a well-known manner for interfacing with a network. In the exemplary embodiment depicted in FIG. 2, the network includes the user PCs 118.

The aircraft integrated SATCOM terminal (AIST) 116 provides interface functions enabling two-way communications, by linking broadband high-speed communications signals between the satellite 120 and the user PCs 118 via the aircraft data pipe 117. In order to achieve this two-way communications link, the aircraft integrated SATCOM terminal 116 includes the satellite antenna 119.

In various exemplary embodiments, the satellite antenna 119 is a tail mounted antenna sub-system (TMASS). In various exemplary embodiments, the aircraft integrated SATCOM terminal 116 includes an airborne integrated transceiver router (AITR) and an antenna control unit (ACU) which are sufficiently small to fit in the limited space available on, and are able to operate under the limited power available on, an executive business jet or other small commercial or private aircraft. In various other exemplary embodiments, the satellite antenna 119 is conformal to the aircraft surfaces and/or is mechanically or electronically steered.

In various exemplary embodiments, the airborne integrated transceiver router, the antenna control unit, and the tail mounted antenna sub-system 119 of the aircraft integrated SATCOM terminal 116 are physically enclosed within separate housings or enclosures, and physically located in separate locations distributed within the aircraft 110. Similarly, other exemplary embodiments employing other subassemblies in the aircraft integrated SATCOM terminal 116 have all subassemblies and components of the aircraft integrated SATCOM terminal 116 physically located within a single enclosure, have each subassembly physically located within its own housing or enclosure, or have some combination of combined and individual housings or enclosures and physical locations.

In various exemplary embodiments where high-speed broadband communications are achieved across a Ku-band satellite 120, the satellite antenna 119 provided as part of the aircraft integrated SATCOM terminal 116 has significant gain and directivity factors. In such exemplary embodiments, the satellite antenna 119 is highly directional, so that it can accurately point at the satellite 120. In such exemplary embodiments, the satellite antenna 119 of the aircraft integrated SATCOM terminal 116 is able to maintain communications with the satellite 120 while the aircraft 110 is engaging in maneuvers while in flight, such as changing its location and orientation. Thus, in such exemplary embodiments, the satellite antenna 119 of the aircraft integrated SATCOM terminal 116 is able to respond quickly to positional and other orientation information that prompt the satellite antenna 119 to move in response to positional or orientational movement by the aircraft 110. In such exemplary embodiments, the satellite antenna 119 of the aircraft integrated SATCOM terminal 116 is able to receive both horizontally and vertically polarized satellite communication signals via the downlink communications path 112. In such embodiments, the satellite antenna 119 of the aircraft integrated SATCOM terminal 116 includes polarization offsets to account for look angles to the geosynchronous or non-geosynchronous arc of the satellite 120.

It should be appreciated that, in various exemplary embodiments where the high-speed broadband communications system 100 employs either a Ku-band or Ka-band or higher satellite 120, the Ku-band or higher signal will experience a relatively high loss in a coaxial cable. Thus, it should be appreciated that, to achieve optimal performance in a Ku-band or higher embodiment of the mobile airborne high-speed broadband communication system 100, a transceiver with an L-band intermediate frequency (or other frequency band) should be located as close as possible to the satellite antenna 119 of the aircraft integrated SATCOM terminal 116 in order to minimize loss of the signal in the cable.

Such a transceiver will typically include a low-noise Ku-band or Ka-band or higher amplifier and a down-converter to the L-band or other intermediate frequency band on a receiver side and an up-converter from the L-band or other intermediate frequency band feeding to a Ku-band, or Ka-band or higher, power amplifier on the transmitter side. Thus, in such exemplary embodiments, the transceiver is an arbitrary collection of functions rather than a single function or a single apparatus. However, the functionality of the transceiver in such exemplary embodiments is provided within a single housing or enclosure, within discrete housings or enclosures, or within a combination of housings. It should nevertheless be appreciated that, in such exemplary embodiments of the mobile platform high-speed broadband communication system 100, to minimize loss in the cables, the transceiver is mounted as close as possible to the satellite antenna 119 of the aircraft integrated SATCOM terminal 116.

In various exemplary embodiments, the satellite antenna of the aircraft integrated SATCOM terminal 116 is connected to an on-board navigation system to provide data used by the satellite antenna 119 of the aircraft integrated SATCOM terminal 116 to maintain a communications lock on the satellite 120. In such exemplary embodiments, the satellite antenna 119 of the aircraft integrated SATCOM terminal 116 is able to maintain constant communications with the satellite 120 via the downlink communications path 112 and the uplink communications path 114 through the entire expected range of motion and speed of the aircraft 110, and through all expected maneuvers of the aircraft 110 within those expected ranges of motion and speed. In such exemplary embodiments, the mobile platform high-speed broadband system 100 also corrects for the Doppler effect of the mobile platform high-speed broadband communications system 100 heading toward, or away from, the satellite 120, throughout all expected maneuvers of the aircraft 110 within those expected ranges of motion and speed.

In various exemplary embodiments, developed for use on small aircraft, a mechanically steered satellite antenna I 19 of the aircraft integrated SATCOM terminal 116 has an aperture of less than 12 inches (0.30 m). In various exemplary embodiments, the satellite antenna 119 of the aircraft integrated SATCOM terminal 116 is an electronically steered phased-array antenna usable to maintain a line-of-sight orientation with the satellite 120. It should be apparent that an electronically steered satellite antenna of the aircraft integrated SATCOM terminal 116 that is capable of maintaining a moving lock on the satellite 120 is relatively more expensive and more power consumptive than a mechanically steered satellite antenna used with the aircraft integrated SATCOM terminal 116. Thus, it should be apparent that, in certain exemplary embodiments having other satellite systems, for example a low earth orbit (LEO) satellite that is not in a geosynchronous orbit, a fixed satellite antenna of the aircraft integrated SATCOM terminal 116 is used. In such alternative embodiments, the non-geosynchronous satellite 120 performs the same communication functions as previously described for the geosynchronous satellite 120. This exemplary embodiment may use either a fixed satellite antenna 119 or a tracking (steered) antenna 119 as part of the aircraft integrated SATCOM terminal 116.

In various exemplary embodiments, the communication flow control function of the aircraft integrated SATCOM terminal 116 is employed to simultaneously transmit and receive return link signal components and forward link signal components for the multiple user PCs I 18. In such exemplary embodiments, multiple users operate a plurality of the user PCs 118 simultaneously. Thus, in such exemplary embodiments, multiple return link signal components are transmitted from the satellite antenna 119 of the aircraft integrated SATCOM terminal 116 via the uplink communications path 114 or are received by the satellite antenna 119 of the aircraft integrated SATCOM terminal 116 via the downlink communications path 112. The aircraft integrated SATCOM terminal 116 achieves the simultaneous transmission and/or the simultaneous reception of these plurality of forward link signal components and/or plurality of return link signal components by integrating and processing those respective signal components. In this manner, the aircraft integrated SATCOM terminals 116 of multiple aircraft 110 utilize the communications bandwidth available from a single transponder on the satellite 120 more efficiently than in conventional airborne data communications systems.

In the exemplary embodiment depicted in FIG. 2, the terminal end of the forward link components of the communication signals is at the user PCs 118. Likewise, in this exemplary embodiment, the return link signal components originate at the user PCs 118.

The exemplary embodiment of the mobile airborne high-speed broadband communications system depicted in FIG. 2 includes a connection to the Internet 170. Various other exemplary embodiments include several other communications signal destinations. In this exemplary embodiment, the Internet 170 is connected to the remote network 160 via a well-known communications path 162. A return link component of a communications signal is transmitted from the remote network 160 to the Internet 170 via a well-known communications path 162 when the Internet 170 is the final destination intended for the return link component of the communications signal. For example, when the user operating the user PC 118 desires to access an Internet website, a return link communications signal originates at the user PC 118 requesting access to the desired Internet website on the Internet 170. That return link communication signal is transmitted through various elements of the mobile airborne high-speed broadband communications system 100 previously described, eventually reaching the remote network 160. In the depicted embodiment, access to remote network 160 is governed by the access management server 150. Thus, in the depicted embodiment, the remote network 160 is a secure private network. In various other embodiments, the remote network is not a secure private network.

The return link communication signal is then transmitted from the remote network 160 to the Internet 170 via the communications path 162. In this embodiment, a server for that page on the Internet 170 then possibly generates the requested website content and transmits it to the remote network 160 via the communications path 162. That content, constituting the forward link communications signal component in such exemplary embodiments, is then transmitted back to the requesting user PC 118 through the various elements of the mobile airborne high-speed broadband communications system 100 previously described, and terminates at the user PC 118. Because the network 160 is a secure private network in this embodiment, the users' vulnerable point of contact with the public Internet 170 is moved to communications path 162.

In various alternative exemplary embodiments, the Internet 170 is situated in the location occupied by the remote network 140 in the embodiment depicted in FIG. 2. Thus, in these various alternative exemplary embodiments, the access management server 150 is accessed from the base station 130 through the Internet 170.

The remote network 160 is also connected to a private user network 180 via a well-known communications link 164. In various exemplary embodiments, return link communications signals that have been authorized through the access management server 150 are transmitted from the remote network 160 to the private user network 180 via the well-known communications path 164. In these embodiments, forward link communications signals originate at the private user network 180 and are transmitted to the remote network 160 via the communications path 164.

In various exemplary embodiments, the private user network 180 is a corporate local area network (LAN). In such exemplary embodiments, a user operating the user PC 118 is a person authorized to access the private user network 180. The user at the user PC 118 originates a return link signal at the user PC 118. That return link signal passes through various components of the mobile airborne high-speed broadband communications system 100 previously described, provided that it has been authorized through the access management server 150, and eventually reaches the corporate local area network 180. In such exemplary embodiments, a forward link communications signal originates at the private user network 180 that is intended for the authorized corporate representative working at the user PC 118. That forward link communications signal is transmitted from the private user network 180 to the remote network 160 via the communications path 164 and continues to pass through the various components of the mobile airborne high-speed broadband communications system 100 previously described until reaching the authorized user PC 118.

In various exemplary embodiments of the mobile airborne high-speed broadband communications system 100, a dedicated connection is provided between the remote network 160 and the access management server 150. In some such exemplary embodiments, a dedicated connection is also provided between the access management server 150 and the remote network 140. In such exemplary embodiments, the dedicated connections between the access management server 150 and the remote networks 140 and 160 include dedicated packet data connections enabling connectivity between the base station 130, the private user networks 180 and the Internet 170. As previously mentioned, it should be appreciated that the mobile airborne high-speed broadband communications system 100 is not limited to a single satellite 120 and a single base station 130. Thus, in various other exemplary embodiments, the mobile airborne high-speed broadband communications system 100 is implemented with an access management server 150 that is connected through the remote network 140 to multiple base stations 130.

In various exemplary embodiments, the base station 130 includes a ground earth station and a network operation center. In some such exemplary embodiments, the network operation center is co-located with the ground earth station. In various other exemplary embodiments, the network operation center is located separately from the ground earth station. In either case, the network operation center and the ground earth station both constitute parts of the base station 130. In various exemplary embodiments, the aggregate uplink effective isotropic radiated power (EIRP) spectral density from all active aircraft integrated SATCOM terminals 116 in the mobile airborne high-speed broadband communications system 100, is controlled by the network operation center.

The exemplary embodiments of the mobile airborne high-speed broadband communications system 100 depicted in FIG. 2 thus is capable of providing a two-way packet data network data pipe as described. In such exemplary embodiments, Internet protocol packets are encapsulated by lower layer protocols, such that a transparent conduit exists for the Internet protocol packets to be transported from the aircraft 110 to a desired host, such as a private user network 180 or the Internet 170, and from that desired host to the aircraft 110.

In various exemplary embodiments, the return link communications signals and the forward link communications signals transmitted between the various components of the mobile airborne high-speed broadband communications system 100 are transmitted using known advanced waveform shaping, such as the previously described Gaussian minimum shift keying (GMSK) and square root raised cosine (SRRC) applied to offset quadrature phase shift modulation (OQPSK), and spread across the transponder spectrum using well-known direct sequence spread spectrum techniques. Such exemplary embodiments also use commercially available performance enhancement techniques on data in the forward link communications signals and in the return link communications signals, packetized according to the well-known TCP/IP Internet protocol.

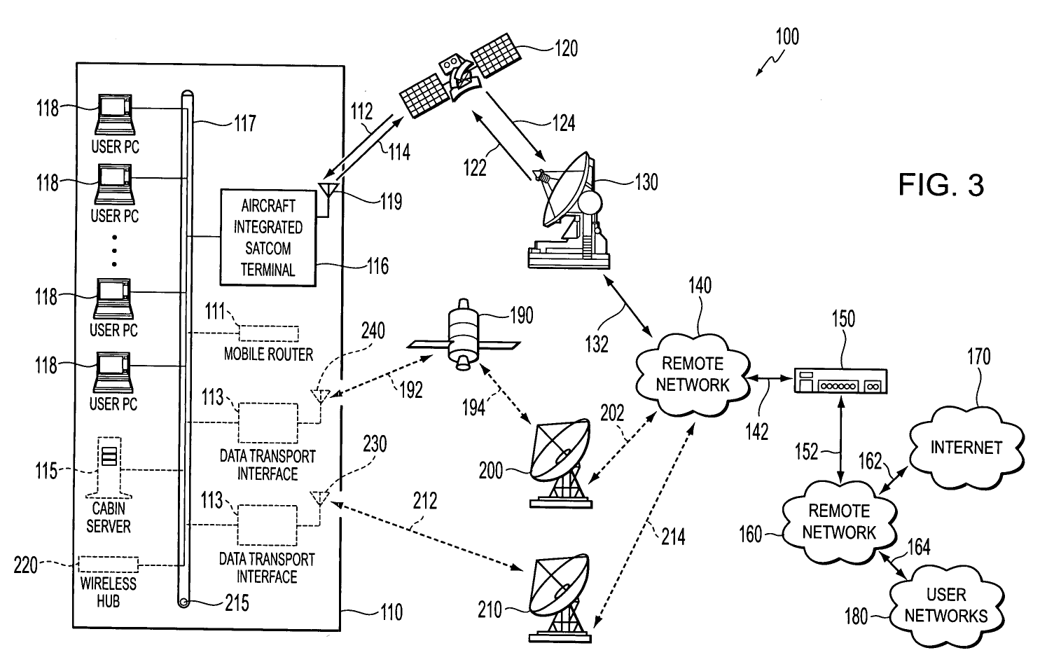

FIG. 3 is a schematic diagram of a third exemplary embodiment of the mobile airborne high-speed broadband communications system 100 according to this invention, illustrating an application with various communications systems. To the extent that various elements of the mobile airborne high-speed broadband communications system 100 in FIG. 3 were previously described in detail in connection with FIG. 1 or FIG. 2, a detailed description of those elements will be omitted in connection with FIG. 3.

As shown in FIG. 3, in this exemplary embodiment, the aircraft 110 includes a mobile router 111, a number of data transport interfaces 113, a cabin server 115, a wireless hub 220, and a communications antenna 230. The communications antenna 230 is connected to one of the data transport interface 113. The data transport interfaces 113 are connected to the aircraft data pipe 117. Likewise, the mobile router 111, the cabin server 115, and the wireless hub 220 are connected to the aircraft data pipe 117. Thus, the aircraft data pipe 117 serves as a conduit for communications between the mobile router 111, the data transport interfaces 113, the cabin server 115, the aircraft integrated SATCOM terminal 116, the user PCs 118, and the wireless hub 220. In this exemplary embodiment, the mobile router 111 seamlessly controls all communications systems connected to the access management server 150 that are routed through the remote network 140.

In this exemplary embodiment, one of the data transport interfaces 113 is in communication with a second satellite 190 via an antenna 240 and a communications path 192. The second satellite 190 is in communications with a base station 200 via a communications path 194. The base station 200 is in communication with the ground network 140 via a communications path 202. This communications path is an alternative path provided to augment the communications path previously discussed in connection with FIGS. 1 and 2. In this exemplary embodiment, communications between a user PC 118 and the ground network 140 via the satellite 190 and the base station 200 is not necessarily high-speed or broadband in either the forward or return communications links.

In another exemplary embodiment, one of the data transport interfaces 113 is in communication with a base station 210 via an antenna 230 and a communications path 212. Non-high-speed broadband communications from the aircraft 110 to the base station 210 are transmitted from the communications antenna 230 via the communications path 212. Likewise, non-high-speed broadband communications from the base station 210 to the aircraft 110 are transmitted via the communications path 212 and received by the communications antenna 230. Thus, communications between the aircraft 110 and the base station 210 are direct communications that do not pass through a satellite such as the satellite 120 or the second satellite 190. Return link communications signals from the aircraft 110 are routed to the ground network 140 from the base station 210 via the communications path 214. Thus, forward link communications signals are routed from the ground network 140 to the base station 210 via the communications path 214. This communications path is yet another alternative path provided to augment the communications path previously discussed in connection with FIGS. 1 and 2. It is usable primarily for voice-grade communications.

Thus, the additional communications paths 192, 194, 202, 212 and 214, for transmitting return link communications signals and forward link communications signals from the aircraft 110 to the ground network 140, shown in FIG. 3, represent alternatives to the communications paths 112, 114, 122, 124 and 132, for transmitting forward link communications signals and return link communications signals from the aircraft 110 to the ground network 140 previously described in connection with FIGS. 1 and 2. These alternative communications paths 192, 194, 202, 212 and 214, are available in these embodiments for variety of reasons.

First, one of the alternative communications routes, that is, one of the communications path 192, 194 and 202 or the communications path 212 and 214, may be used during a temporary hardware failure in the aircraft integrated SATCOM terminal 116. In another exemplary embodiment, one or more of the alternative communications routes, that is, ones of the communications path 192, 194 and 202 or the communications path 212 and 214, are used temporarily during a temporary interruption of communications between the aircraft integrated SATCOM terminal 116 and the satellite 120, for example, when the aircraft 110 leaves the coverage footprint of the satellite 120, or between the satellite 120 and the base station 130, or between the base station 130 and the ground network 140.

The second satellite 190 is, in various exemplary embodiments, a low earth orbit (LEO) satellite system. In various other embodiments, the second satellite 190 is a medium earth orbit (MEO) satellite system. In still other exemplary embodiments, the second satellite 190 is another satellite designed primarily for voice service, such as the satellites of the Iridium, Global Star, Inmarsat or Odyssey systems.

In various exemplary embodiments where the second satellite 190 is designed primarily for voice service, the second satellite 190 might not be capable of achieving the same performance levels for high-speed broadband communications as the satellite 120. For example, many of the previously-mentioned embodiments of the second satellite 190 are capable only of communications at bit rates of 1.2 to 9.6 kbps, using a voice band modem signaling similar to a conventional two-way data service, such as those currently available from the North American telephone system and the European terrestrial flight telephone system. With recent well-known technological developments, it is possible to connect multiple channels together in a dedicated manner to increase the data communications rate up to 128 kbps.

The mobile router 111, the cabin server 115 and the wireless hub 220 are networking components expanding the form and the capabilities of the network of the user PCs 118 within the aircraft 110. The mobile router 111 enables communications with the second satellite 190 and the base station 210 via the data transport interfaces 113. In such exemplary embodiments, the mobile router 111 selects and controls the communications paths to the access control server 150 for return links, forward links, or both. In such exemplary embodiments, the satellite network is connected to the mobile router 111, enabling it to handle routing and handoffs occurring when linking the user PCs 118 to the ground network 140 in a well-known manner similar to that used by conventional cellular telephone systems for use on an aircraft.

Thus, the exemplary embodiments of the mobile airborne high-speed broadband communications system 100 shown in FIG. 3 are used, in various exemplary embodiments, to communicate return link communications signals and forward link communications signals between the aircraft 110 and the ground network 140 via the North American telephone system, the European terrestrial flight telephone system, a direct air link to a terrestrial gateway, a link to a low-earth-orbit and/or a medium-earth-orbit satellite system, and/or a communications link to another broadband satellite-based system, including the digital broadcast satellites (DBS) or the teledesic systems.

Exemplary embodiments containing the most alternative communications paths for the return link communications signals and the forward link communications signals are believed better able to maintain the most consistent and robust communications between the user PCs 118 and the ground network 140. It should also be appreciated that, in various exemplary embodiments, the aircraft data pipe 117 is also connected to a network printer to enable the user PCs 118 to print information received from the remote network 140 in a forward link communications signal.

The bandwidth available to the mobile airborne high-speed broadband communications system I 00 enables users at the user PCs 118 to participate in communications applications, including, but not limited to, video conferencing, high-quality video, high-speed Internet, and virtual local area networking, while traveling in the aircraft 110.

In the exemplary embodiment shown in FIG. 3, the aircraft data pipe 117 is implemented by a switch 215. In various exemplary embodiments, the switch 215 is an Ethernet switch that enables the aircraft integrated SATCOM terminal 116 to employ an Internet protocol port that is a part of a local area network on the aircraft 110 having several user PCs 118. In such exemplary embodiments, the aircraft integrated SATCOM terminal 116, and the associated satellite sub-network, support a connection to the aircraft local area network. In such exemplary embodiments, the multiple users operating the user PCs 118 share the resources allocated to the aircraft integrated SATCOM terminal 116 from the satellite 120. Thus, the multiple users operating the multiple user PCs 118 connected to the aircraft data pipe 117 share the bandwidth available to the aircraft integrated SATCOM terminal 116 on the satellite 120. Although available resources, such as bandwidth, are shared in such exemplary embodiments, in some exemplary embodiments, each individual user PC 118 presents a unique Internet protocol address identifier to the rest of the network.

In other exemplary embodiments, the aircraft integrated SATCOM terminal 116 presents the satellite 120 with a single user identifier while having multiple users operating multiple user PCs 118 connected to the aircraft data pipe 117 in an area network local to the aircraft 110. It should be appreciated that these exemplary embodiments prevent the access management server 150, the Internet 170, and the user networks 180 from distinguishing between the individual users operating the user PCs 118 on the aircraft 110. It should also be appreciated that additional software may be necessary to enable the cabin server 115 to operate as an intermediary for the user PCs 118 in such exemplary embodiments.

Although the exemplary embodiments depicted in FIGS. 1-3 show only one aircraft 110, it should be apparent that other embodiments exist wherein a plurality of aircrafts 110 are all simultaneously in communication with the satellite 120 by way of the individual downlink and uplink communications paths 112, 114, 122 and 124 corresponding to each individual aircraft 110. In such exemplary embodiments with a plurality of aircraft 110, there are a plurality of aircraft integrated SATCOM terminals 116, each associated with one of the plurality of aircraft 110. When a plurality of aircraft integrated SATCOM terminals 116 are in communication with the single satellite 120, each aircraft integrated SATCOM terminal 116 logs on to a system network using a unique Internet protocol (IP) address or a block of Internet protocol addresses.

In various exemplary embodiments, the Internet protocol address is, or block of Internet protocol addresses are, permanently assigned to each individual aircraft integrated SATCOM terminal 116. The unique aircraft integrated SATCOM terminal 116 identifier is assigned (authorized) when the aircraft integrated SATCOM terminal 116 is commissioned into the high-speed broadband communication system 100. Upon receiving a communication from an aircraft integrated SATCOM terminal 116, the base station 130 will not establish a connection with the aircraft integrated SATCOM terminal 116 unless the aircraft integrated SATCOM terminal 116 is identified by an authorized identifier recognized by the base station 130.

In various exemplary embodiments, an exception to the previously described standard applies. In such exemplary embodiments, the exception is that a connection with an aircraft integrated SATCOM terminal 116 will be accepted by the base station 130 for the purpose of commissioning an authorization identifier to that aircraft integrated SATCOM terminal 116.

It should be apparent that, in these exemplary embodiments with a plurality of aircraft 110, at times the base station 130 simultaneously receives a plurality of return link signal components, for example, one return link signal component from two or more of the plurality of aircraft 110. In such exemplary embodiments, the return link signal components from distinct aircraft 110 are distinguished using known signal processing techniques. Further, in such exemplary embodiments, the base station 130 may receive, in addition to the plurality of discrete return link signal components, forward link signal components retransmitted back to the base station 130 via the downlink communications path 124 and intended, for two or more of the plurality of the aircraft 110. Similarly, in such exemplary embodiments, the plurality of the aircraft 110 may simultaneously receive forward link and return link signal components intended for two or more of a plurality of aircraft 110 via the individual downlink communications paths 112. In such exemplary embodiments, the return link signal components from the aircraft 110 are not perceived by the aircraft 110 because they are much lower in power than the forward link signal components, as previously described.

In various exemplary embodiments, the content of the signals communicated via the downlink communications path 112, the uplink communications path 114, the uplink communications path 122, and the downlink communications path 124 is formatted in a well-known manner into digital data packets according to the Internet protocol (IP). In these exemplary embodiments, the forward communications link signal uses a signaling rate between 512 kbps and 3.5 Mbps. In such exemplary embodiments, the aircraft integrated SATCOM terminal 116 routes requested data communications to the requesting user PCs 118, and discards other forward link data packets not specifically addressed to the aircraft 110 in a known manner. The aircraft integrated SATCOM terminal 116 accepts all valid digital data packet requests from the user PCs 118, and routes them via the return link signal to the base station 130, as previously described.

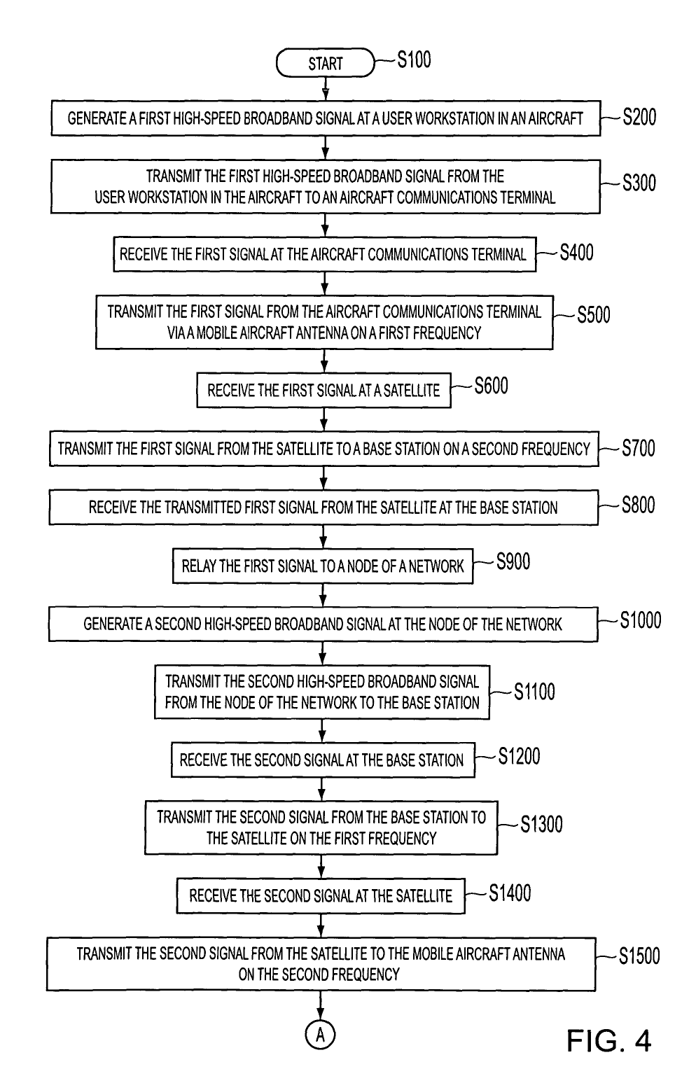

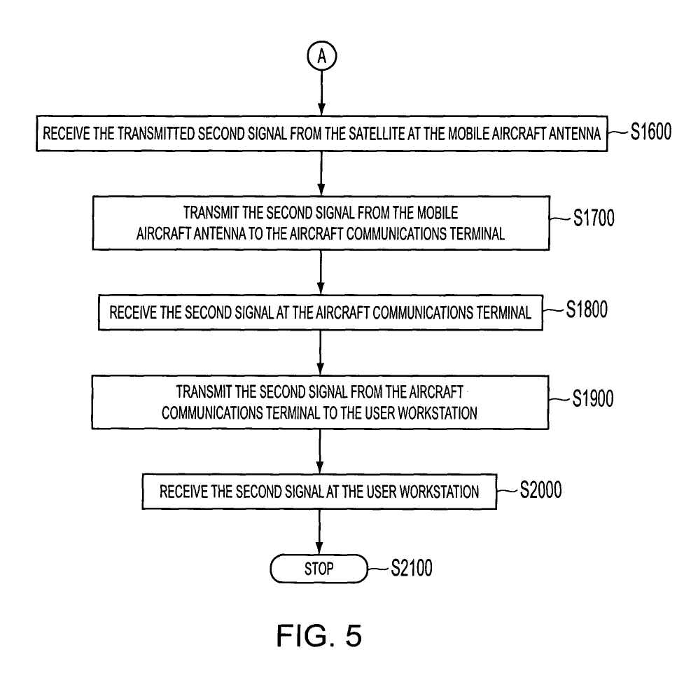

FIGS. 4 and 5 are flowcharts outlining one exemplary embodiment of a method for mobile airborne high-speed broadband communications according to this invention. Beginning in step S100, control proceeds to step S200, where a first high-speed broadband signal is generated at a user data processing device that is located in an aircraft. Next, in step S300, the first high-speed broadband signal is transmitted from the user data processing device in the aircraft to an aircraft communications terminal. Then, in step S400, the first high-speed broadband signal from the user data processing device is received at the aircraft communications terminal. Operation then continues to step S500.

In step S500, the first high-speed broadband signal is transmitted from the aircraft communications terminal on a first frequency. In various exemplary embodiments the transmission in step S500 from the aircraft communications terminal occurs via a mobile aircraft antenna. Then, in step S600, the first high-speed broadband signal transmitted from the aircraft communications terminal is received at a satellite. Next, in step S700, the first high-speed broadband signal is re-transmitted by the satellite to a base station on a second frequency. Operation then continues to step S800.

In step S800, the first high-speed broadband signal transmitted by the satellite is received at the base station. Next, in step S900, the base station relays the first high-speed broadband signal to a node of a network. In step S1000, at some point following step S900, a second high-speed broadband signal is generated at the node of the network.

It should be apparent that the node of the network represents any node of any network and the path by which that node is accessed is not limited to any specific embodiment. Thus, in various exemplary embodiments, the network is a user-designated network. In various other exemplary embodiments, the network is a private secure network. In still other exemplary embodiments, the network is the Internet.

Typically, the second high-speed broadband signal is different than the first high-speed broadband signal. However, it should be appreciated that the second high-speed broadband signal may, in certain embodiments, be the same as the first high-speed broadband signal. It should also be appreciated that, in various exemplary embodiments, the content of the signal is available a priori at that node of the network. Alternatively, in various other exemplary embodiments, the content of the signal is generated dynamically at the node of network or accessed from some other point via the network. Operation then continues to step S1100.

In step S1100, the second high-speed broadband signal generated at the node of the network is transmitted from the node of the network to the base station. Then, in step S1200, the second high-speed broadband signal transmitted from the node of the network is received at the base station. Next, in step S1300, the second high-speed broadband signal is transmitted from the base station to the satellite on the first frequency. Thus, the transmission that occurs in step S1300 is made on the same frequency as the transmission that occurred in step S500. Operation then continues to step S1400.

In step S1400, the second high-speed broadband signal transmitted from the base station on the first frequency is received at the satellite. Then, in step S1500, the second high-speed broadband signal is transmitted from the satellite to the mobile aircraft antenna on the second frequency. Thus, the frequency on which the transmission occurs in step S1500 is the same as the frequency on which the transmission occurred in step S700. In a various exemplary embodiments, the first frequency used for the transmissions in steps S500 and S1300 is different than the second frequency used for the transmissions in steps S700 and S1500. However, in some exemplary embodiments, a single frequency is used for the transmissions in steps S500, S700, S1300 and S1500. Next, in step S1600, the second high-speed broadband signal transmitted from the satellite is received at the mobile aircraft antenna. Operation then continues to step S1700.

In step S1700, the second high-speed broadband signal is transmitted from the mobile aircraft antenna to the aircraft communications terminal. Next, in step S1800, the second high-speed broadband signal transmitted from the mobile aircraft antenna is received at the aircraft communications terminal. Then, in step S1900, the second signal is transmitted from the aircraft communications terminal to the user workstation. Next, in step S2000, the second high-speed broadband signal transmitted from the aircraft communications terminal is received at the user data processing device. Control then proceeds to step S2100, where operation of the method stops.

In one exemplary embodiment, a user operating a laptop computer on an aircraft receives a service initiation acknowledgment message by way of an aircraft communications terminal and a data pipe internal to the aircraft. The user then sends a request to visit a particular website over the laptop computer. This signal is passed to the Internet by way of a satellite link through a node of a network. The desired website responds to the data request by sending the requested data back through the node of the network. Eventually the laptop computer receives the requested Internet data.

In various exemplary embodiments, the mobile airborne high-speed broadband communications systems and methods according to this invention enable high-speed airborne communications utilizing the full bandwidth of a Ku satellite transponder, which is typically about 36 MHz, capable of handling data rates of about 10 Mbps. Another advantage of a mobile airborne high-speed broadband communications system and method according to the invention is the ability to operate using any known satellite system. In this manner, a form of mobile airborne communications is achieved that can communicate using any currently known or later-developed communications system in any currently known or later-developed application or place.

Likewise, various embodiments according to the invention employ a modularized infrastructure that improves the simplicity with which a mobile airborne high-speed broadband communications system can be expanded by adding new components or by replacing certain components with newer and improved components when they become available. For example, as new types of system interfaces become available, they can be easily integrated into a mobile airborne high-speed broadband communications system according to the invention. In the same manner, later-developed hardware and other technologies can be incorporated in a mobile airborne high-speed broadband communications system according to the invention with minimal development costs.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention, including, but not limited to, variations expressly mentioned. Therefore, the claims as filed and as they may be amended are intended to embrace all known or later-developed alternatives, modifications, variations, improvements, and/or substantial equivalents.

1. A mobile platform high-speed broadband communications system for a mobile platform, the mobile platform high-speed broadband communications system comprising:
a mobile communications terminal having a single first antenna;
a satellite in two-way communication with the mobile communications terminal through the first antenna; and
a base station in two-way communication with the satellite, wherein
a return link signal is transmitted from the first antenna of the mobile communications terminal to the satellite on a first frequency;
the return link signal is retransmitted from the communications satellite to the base station on a second frequency;
a forward link signal is transmitted from the base station to the satellite on the first frequency;
the forward link signal is retransmitted from the satellite to the first antenna of the mobile communications terminal on the second frequency; and
the forward link signal is received by the first antenna.

2. The mobile platform high-speed broadband communications system for a mobile platform according to claim 1, wherein the mobile communications terminal and the first antenna are in an aircraft.

3. The mobile platform high-speed broadband communications system for a mobile platform according to claim 1, wherein the mobile platform includes the mobile communications terminal and the first antenna, and the first antenna is capable of maintaining a communications lock on the satellite when the mobile platform is in motion.

4. The mobile platform high-speed broadband communications system for a mobile platform according to claim 1, wherein:
the return link signal from the mobile communications terminal to the communications satellite, and the forward link signal from the base station to the communications satellite are received by a single transponder of the satellite; and
the forward link signal from the communications satellite to the base station, and the return link signal from the satellite to the first antenna of the mobile communications terminal are transmitted by the single transponder of the satellite.

5. The mobile platform high-speed broadband communications system for a mobile platform according to claim 1, further comprising a remote network in communication with the base station, wherein the mobile communications terminal and the antenna are part of the mobile platform.

6. The mobile platform high-speed broadband communications system for a mobile platform according to claim 5, wherein the remote network is a private network.

7. The mobile platform high-speed broadband communications system for a mobile platform according to claim 5, wherein the remote network is the Internet.

8. The mobile platform high-speed broadband communications system for a mobile platform according to claim 5, wherein:
the communication between the remote network and the base station is two-way communication;
the return link signal is a request for data from the Internet; and
the forward link signal is a response to the request.

9. The mobile platform high-speed broadband communications system for a mobile platform according to claim 1, wherein the mobile platform further comprises a data entry device in communication with the antenna of the mobile communications terminal, and the communication between the data entry device and the antenna is two-way communication.

10. The mobile platform high-speed broadband communications system for a mobile platform according to claim 1, wherein the mobile communications terminal further comprises a second antenna in communication with a receiver other than the satellite.

11. A method for high-speed broadband communicating for a mobile platform, the method comprising:
transmitting a first signal from a mobile antenna on a first frequency;
receiving the first signal at a satellite;
transmitting the first signal from the satellite to a base station on a second frequency;
receiving the first signal at the base station;
transmitting a second signal from the base station to the satellite on the first frequency;
receiving the second signal at the satellite;
transmitting the second signal from the satellite to the mobile antenna on the second frequency; and
receiving the second signal at the mobile antenna.

12. The method of claim 11, wherein transmitting the first signal and transmitting the second signal comprise transmitting the first and second signals at different times.

13. The method of claim 12, further comprising generating the second signal in response to the first signal.

14. The method of claim 12, further comprising generating the first signal in response to the second signal.

15. The method of claim 11, further comprising generating the first signal in response to an input by a user at a workstation that is associated with the mobile platform.

16. The method of claim 11, wherein the mobile platform is an airborne aircraft.

17. The method of claim 11, wherein:
receiving the first signal and the second signal at the satellite comprise receiving the first signal and the second signal at a single transponder of the satellite; and
transmitting the first signal and the second signal from the satellite comprise transmitting the first signal and the second signal by the single transponder of the satellite.

18. A method for high-speed broadband communicating for a mobile platform, the method comprising:
generating a first signal at a user workstation in a mobile communications platform;
transmitting the first signal from the user workstation to a communications terminal including an antenna;
transmitting the first signal from the antenna to a satellite on a first frequency;
receiving the first signal at the satellite;
transmitting the first signal from the satellite to a base station on a second frequency;
relaying the first signal from the base station to a node of a remote network;
generating a second signal at the node of the network;
transmitting the second signal from the node of the network to the base station;
transmitting the second signal from the base station to the satellite on the first frequency;
receiving the second signal at the satellite;
transmitting the second signal from the satellite to the mobile communications platform on the second frequency;
receiving the second signal transmitted from the satellite to the mobile communications platform at the antenna of the communications terminal;
transmitting the second signal from the antenna of the communications terminal to the user workstation; and
receiving the second signal at the user workstation.

19. The method of claim 18, wherein transmitting the first signal and transmitting the second signal comprise transmitting the first and second signals at different times.

20. The method of claim 19, further comprising generating the second signal in response to the first signal.

21. The method of claim 19, further comprising generating the first signal in response to the second signal.

22. The method of claim 18, wherein the mobile platform is an airborne aircraft.

23. The method of claim 18, wherein:
receiving the first signal and the second signal at the satellite comprise receiving the first signal and the second signal at a single transponder of the satellite; and
transmitting the first signal and the second signal from the satellite comprise transmitting the first signal and the second signal by the single transponder of the satellite.
